(19) United States
(12) Patent Application Publication
(10) Pub. No.: US 2016/0324075 A1
(43) Pub. Date: Nov. 10, 2016

(54) Planter

(71) Applicants: Chung Wei Huang, Taichung (TW); Wen-Hung Li, Taichung (TW); Cheng Yu Huang, Taichung (TW)

(72) Inventors: Chung Wei Huang, Taichung (TW); Wen-Hung Li, Taichung (TW); Cheng Yu Huang, Taichung (TW)

(21) Appl. No.: 15/216,697

(22) Filed: Jul. 22, 2016

(51) Int. Cl. A01G 9/02

(52) U.S. Cl. CPC A01G 9/021

(57) ABSTRACT

A planter is provided with concentric U-shaped first ridges on a first half portion of a bottom; concentric U-shaped second ridges on a second half portion of the bottom; concentric U-shaped first recesses on a first half portion of an underside; concentric U-shaped second recesses on a second half portion of the underside; a corrugated wall; a flange on a top of the corrugated wall; an upstanding lip on an outer edge of the flange; and a board insert on the flange and including a top surface, a flange member on a bottom edge of the top surface, and rows of bottom holes each having an annular wall.

### BACKGROUND OF THE INVENTION

1. Field of the Invention

The invention relates to planters and more particularly to a planter having increased structural strength.

2. Description of Related Art

A conventional planter comprises a base, a peripheral wall, and a flange on a top of the wall. Soil is placed in a space defined by the base and the wall. Plants are grown on the soil.

While the planter enjoys its success in the market, continuing improvements in the exploitation of planter of this type are constantly being sought.

### SUMMARY OF THE INVENTION

It is therefore one object of the invention to provide a planter comprising a plurality of concentric U-shaped first ridges disposed on a first half portion of a bottom; a plurality of concentric U-shaped second ridges disposed on a second half portion of the bottom; a plurality of concentric U-shaped first recesses disposed on a first half portion of an underside; a plurality of concentric U-shaped second recesses disposed on a second half portion of the underside; a corrugated wall; a flange disposed on a top of the corrugated wall; an upstanding lip disposed on an outer edge of the flange; and a board insert disposed on the flange and including a top surface, a flange member disposed on a bottom edge of the top surface, and a plurality of rows of bottom holes each having an annular wall.

The above and other objects, features and advantages of the invention will become apparent from the following detailed description taken with the accompanying drawings.

### BRIEF DESCRIPTION OF THE DRAWINGS

FIG. 1 is a perspective view of a planter according to a first preferred embodiment of the invention, viewed from the top;

FIG. 2 is another view of the planter viewed from the bottom;

FIG. 3 is a top view of the planter;

FIG. 4 is a side view of the planter;

FIG. 5 is a detailed view of the area in circle A of FIG. 4;

FIG. 6 is a perspective view of a planter according to a second preferred embodiment of the invention, viewed from the top;

FIG. 7 is another view of the planter of FIG. 6, viewed from the bottom;

FIG. 8 is a sectional view along line B-B of FIG. 7;

FIG. 9 is a top view of the planter of FIG. 6;

FIG. 10 is a side view of the planter of FIG. 6;

FIG. 11 is a detailed view of the area in circle C of FIG. 10;

FIG. 12 is a bottom view of the planter of FIG. 6; and

FIG. 13 is a perspective view of the planter of FIG. 6 placed on the top of the planter of FIG. 1 with plants grown on the board insert.

### DETAILED DESCRIPTION OF THE INVENTION

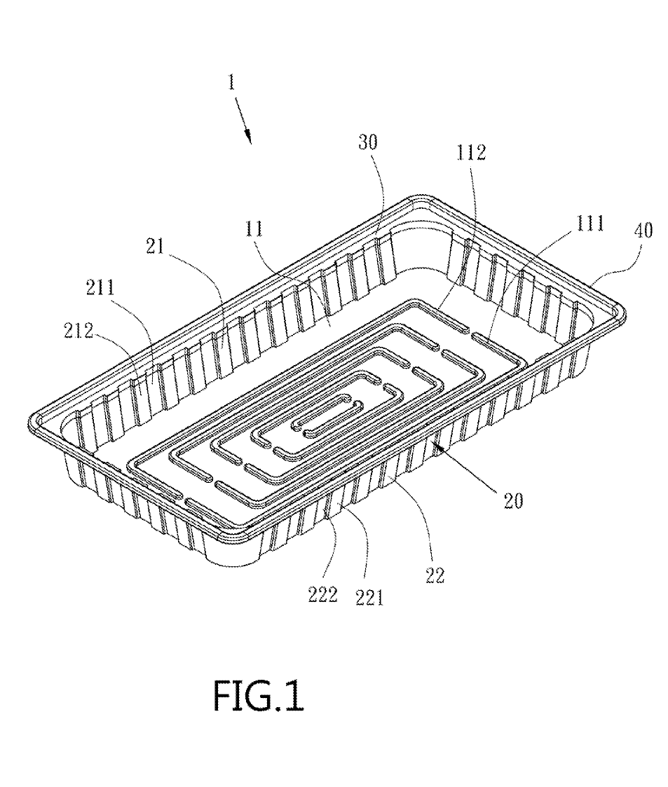

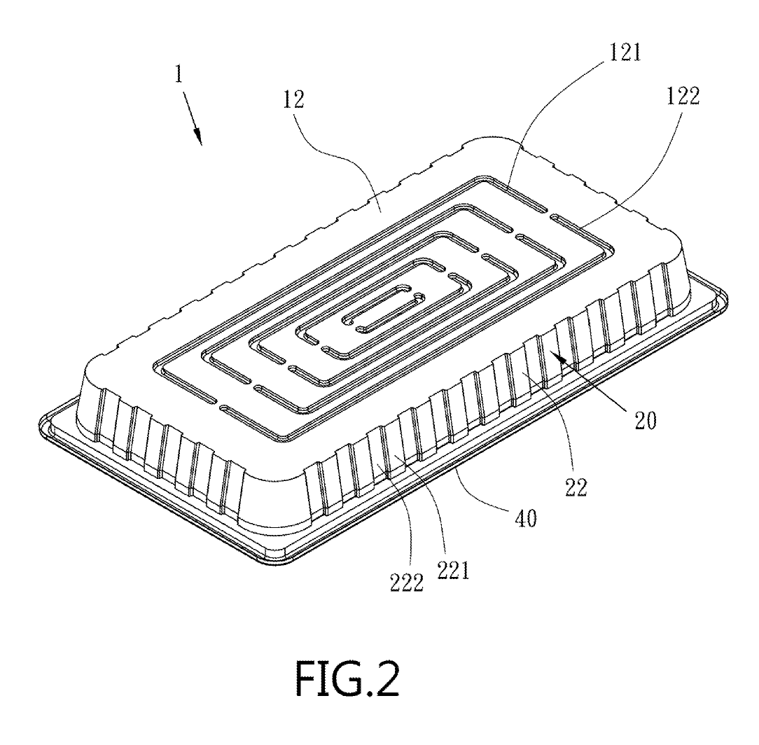

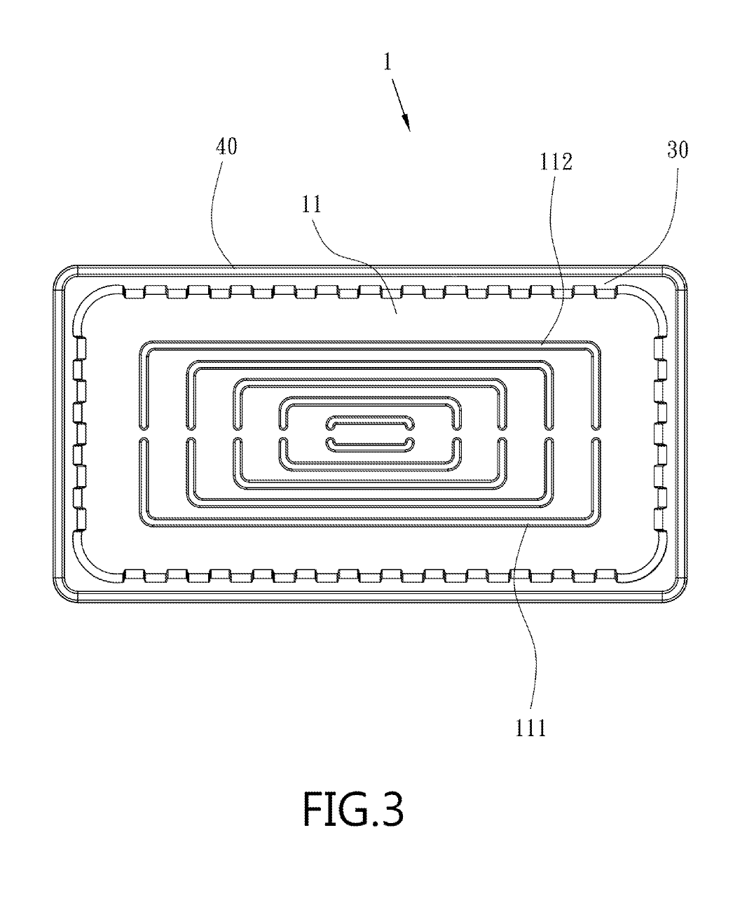

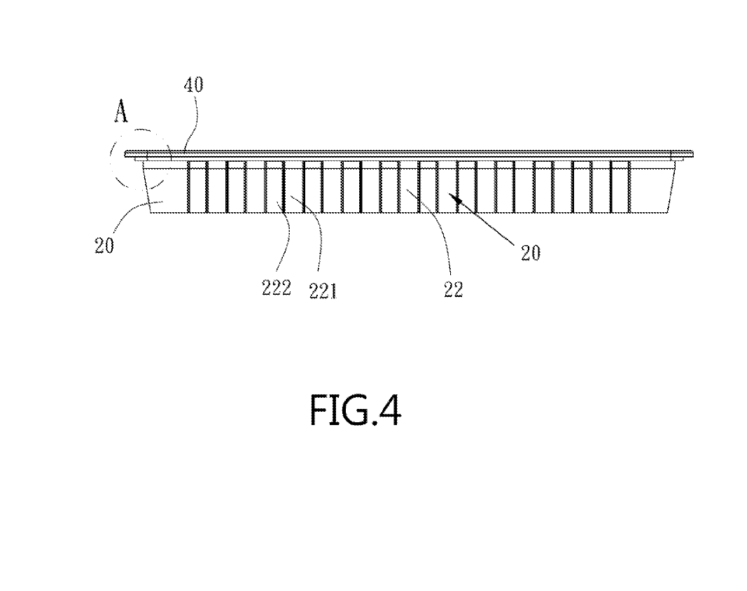

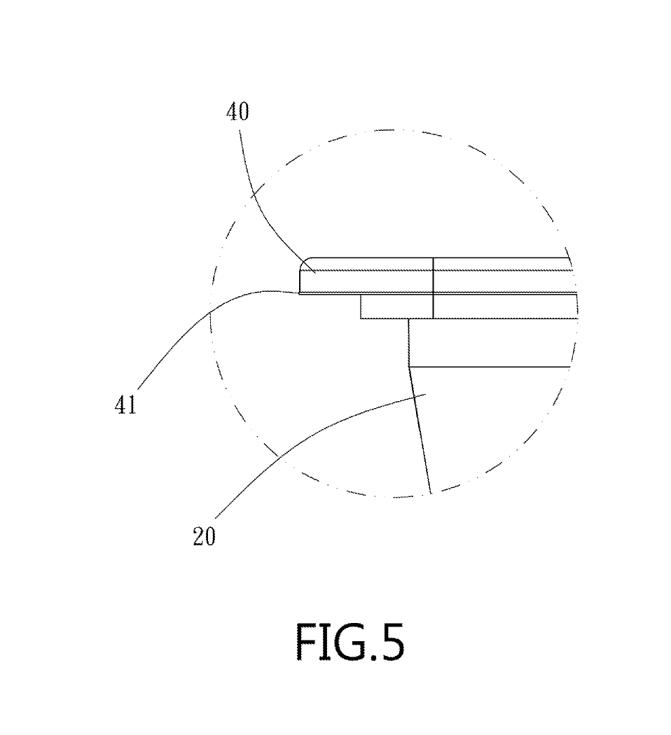

Referring to FIGS. 1 to 5, a planter 1 in accordance with a first preferred embodiment of the invention comprises the following components as discussed in detail below.

A rectangular bottom 11 includes a plurality of concentric U-shaped ridges 111 on a first half portion and a plurality of concentric U-shaped ridges 112 on a second half portion. A plurality of alternate risers 221 and grooves 222 are formed on outer surfaces 22 of four rectangular side walls 20. A plurality of alternate risers 212 and grooves 211 are formed on inner surfaces 21 of the side walls 20. An outward extending flange 30 is formed on top edges of the side walls 20. An upstanding lip 40 is formed on an outer edge of the flange 30. On an underside 12, there are provided a plurality of concentric U-shaped recesses 121 on a first half portion and a plurality of concentric U-shaped recesses 122 on a second half portion. An enhancement member 41 is formed on a bottom of the upstanding lip 40.

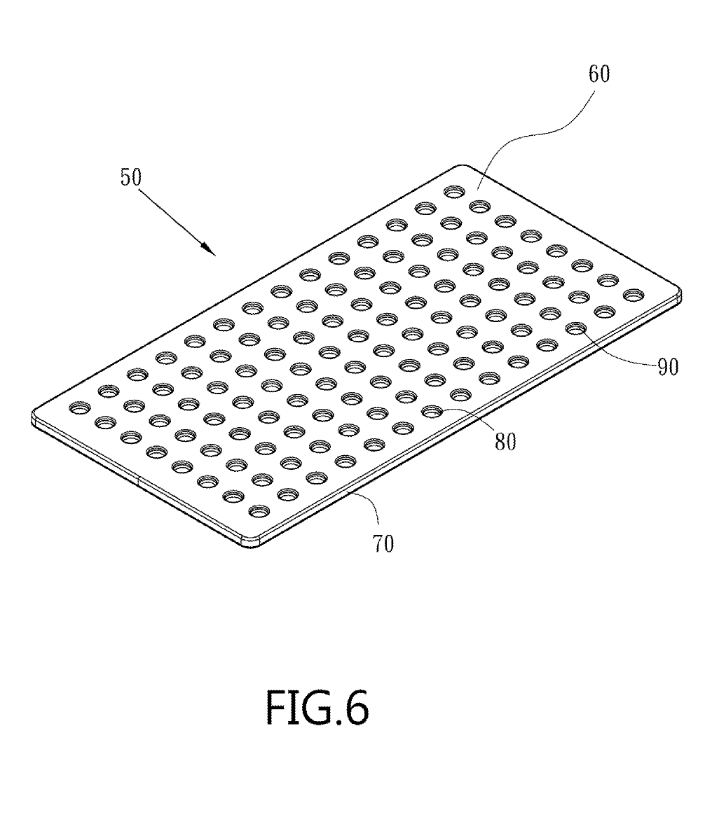

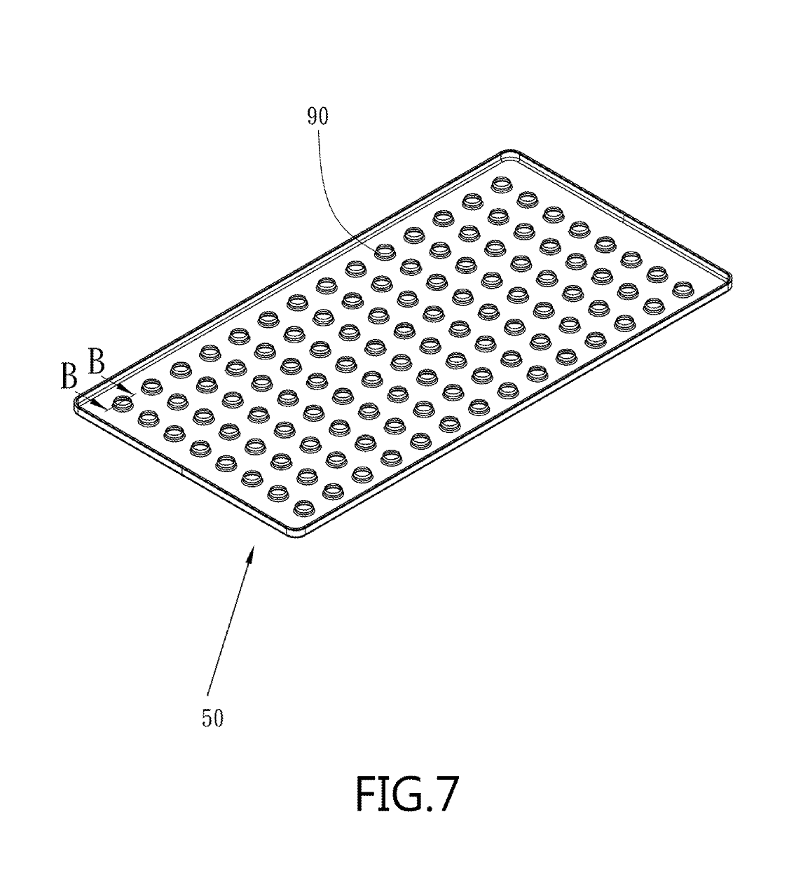

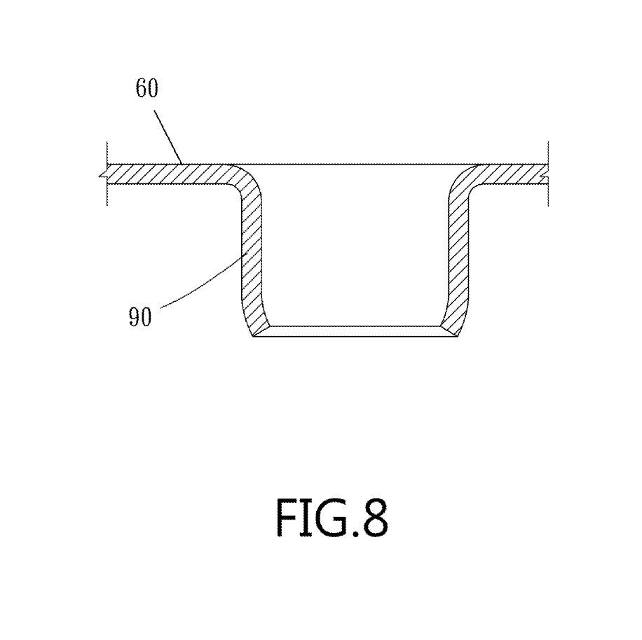

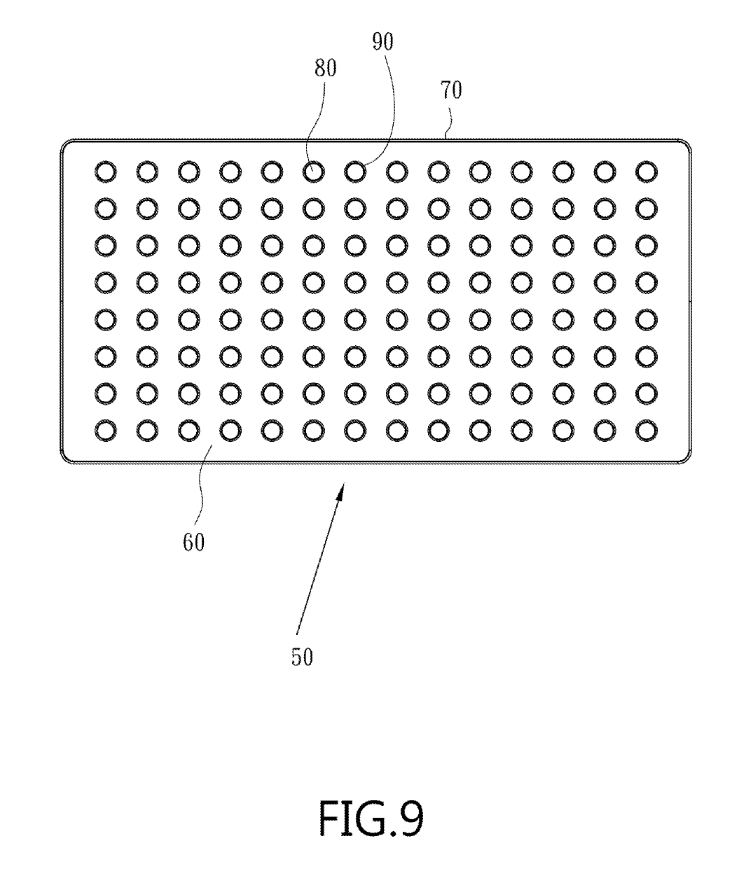

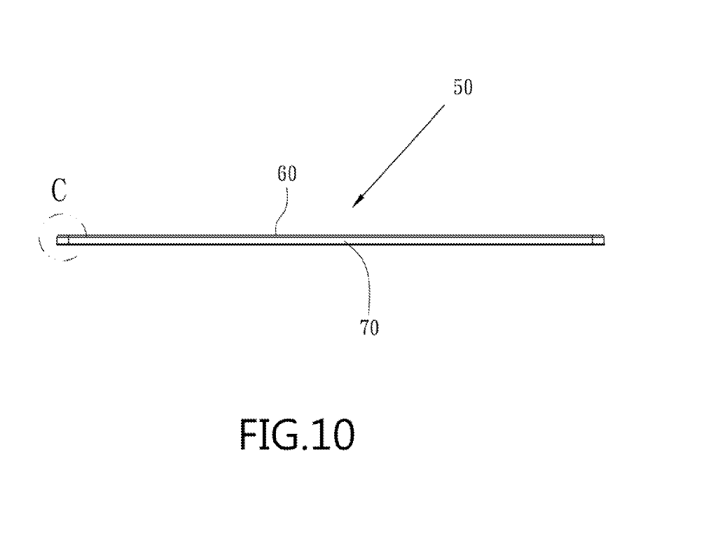

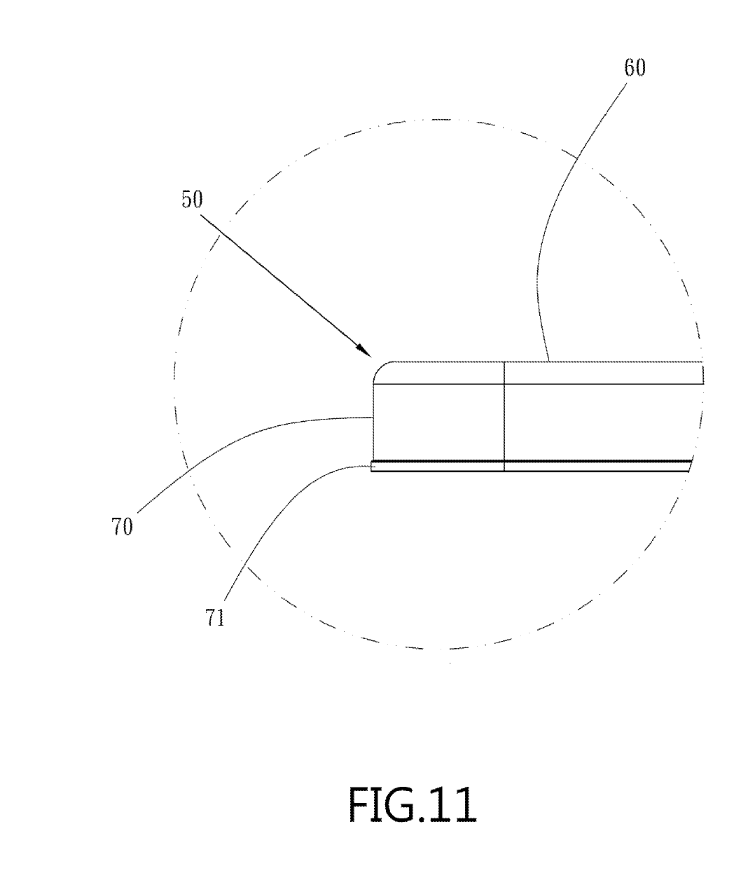

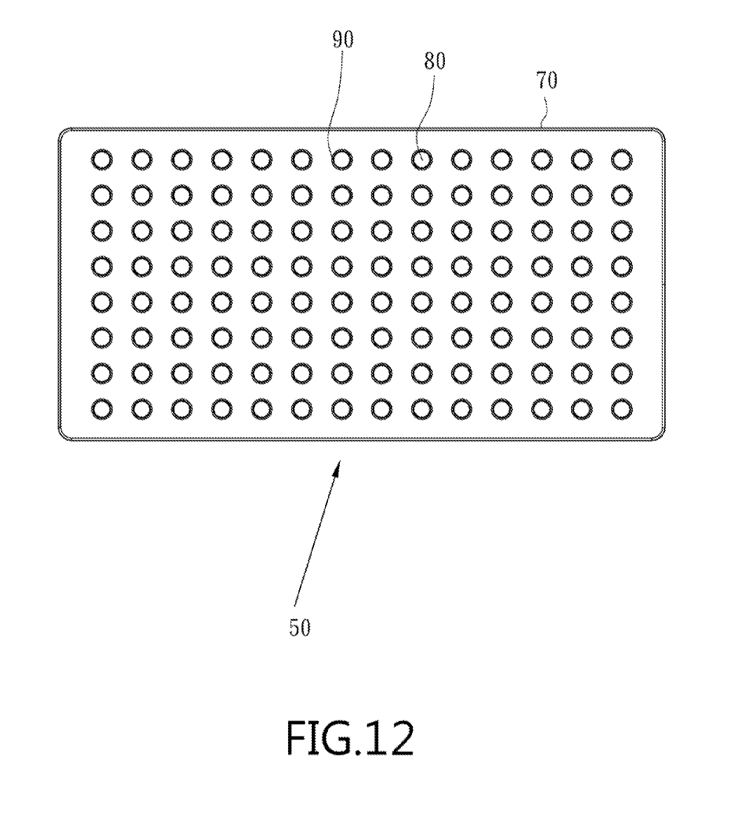

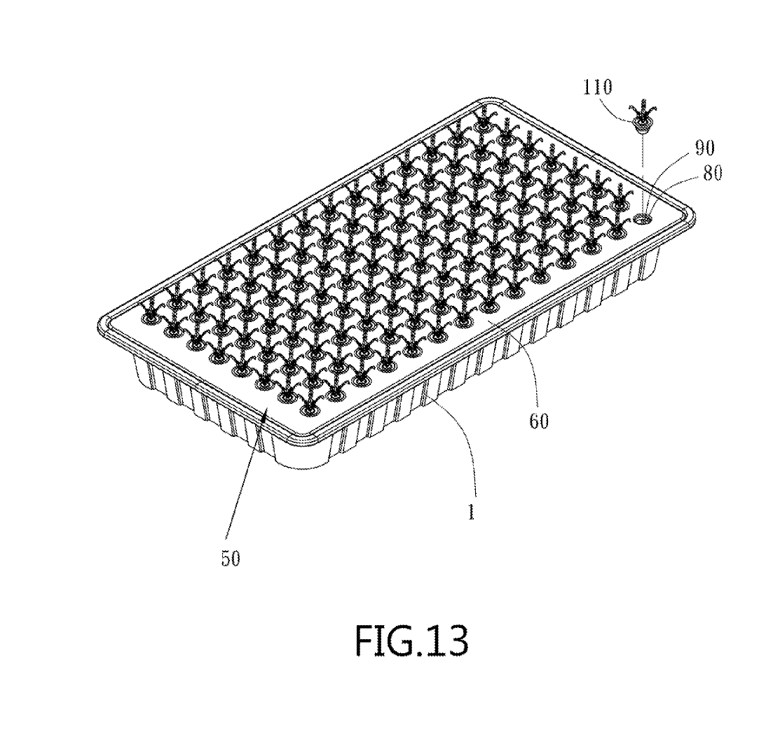

Referring to FIGS. 6 to 13 in conjunction with FIGS. 1 to 5, a planter in accordance with a second preferred embodiment of the invention is shown. The characteristics of the second preferred embodiment are the addition of a rectangular board insert 50 placed on the flange 30 and including a top surface 60, a flange member 70 on a bottom edge of the top surface 60, a plurality of rows of bottom holes 80 each having an annular wall 90 perpendicular to the top surface 60. An enhancement element 71 is formed on a bottom of the flange member 70. A plurality of plants 110 are disposed in the bottom holes 80.

While the invention has been described in terms of preferred embodiments, those skilled in the art will recognize that the invention can be practiced with modifications within the spirit and scope of the appended claims.

What is claimed is:

1. A planter comprising:
a plurality of concentric U-shaped first ridges disposed on a first half portion of a bottom;
a plurality of concentric U-shaped second ridges disposed on a second half portion of the bottom;
a plurality of concentric U-shaped first recesses disposed on a first half portion of an underside;
a plurality of concentric U-shaped second recesses disposed on a second half portion of the underside;
a corrugated wall;
a flange disposed on a top of the corrugated wall;
an upstanding lip disposed on an outer edge of the flange; and
a board insert disposed on the flange and including a top surface, a flange member disposed on a bottom edge of the top surface, and a plurality of rows of bottom holes each having an annular wall.
